(19) United States
(12) Patent Application Publication
(10) Pub. No.: US 2004/0098898 A1
(43) Pub. Date: May 27, 2004

(54) Bird deterrent system for crop protection

(76) Inventor: Richard C. Nickerson, Encino, CA (US)

Correspondence Address: Eric L. Tanezaki, STETINA BRUNDA GARRED & BRUCKER, Suite 250, 75 Enterprise, Aliso Viejo, CA, 92656, US

(21) Appl. No.: 10/305,891

(22) Filed: Nov. 27, 2002

(51) Int. Cl. A01M 1/00

(52) U.S. Cl. 43/1

(57) ABSTRACT

There is provided a system for deterring small animals away from a selected area. The system comprises a central support member having an axis of rotation. Moreover, at least one elongated member is attached to the central support member and extends radially with respect to the axis of rotation. Further, a motor is in mechanical communication with the central support member. The motor is operative to rotate the central support member about the axis of rotation for moving the elongated member(s) about the axis of rotation. Lastly, a controller is in electrical communication with the motor. The controller is configured to activate the motor to rotate the central support member intermittently about the axis of rotation. This moves the elongated member(s) to deter the small animals away from the selected area.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to bird deterrent systems, and more particularly to an improved bird deterrent system which is adapted to rotate at least one elongated member intermittently about an axis of rotation for deterring small animals away from a selected area.

Birds are known to deface properties and destroy crops in agricultural fields. The latter scenario is especially detrimental as the birds instinctively eat away the crops when the agricultural fields are not properly supervised. The crop loss from such occurrence can be quite significant resulting in millions of dollars of damages every year.

Various types of bird deterrents are currently available from manufacturers of agricultural products. Though such currently known and available bird deterrents may achieve their primary objective of deterring the birds to some degree, they possess certain deficiencies which detract from their overall utility.

One type of bird deterrent that is commonly used is a predator-resembling object which is elevated over an agricultural field. This object is typically in the form of a balloon with large painted eyes, a kite shaped like a predator bird (e.g., owls, hawks and the like), or a pole-mounted plastic replica of an owl. However, all of these predator-resembling objects are only effective for a few hours as the birds easily acclimate to their environment and become accustomed to such objects.

Audio systems have also been implemented as a bird deterrent. More specifically, the audio systems are utilized to play bird distress calls over their loudspeakers. However, similar to the predator-resembling objects described above, the birds quickly adapt to their environment and become accustomed to such sounds.

Another type of bird deterrent that has been utilized is a propane cannon which produces obnoxiously loud booming sounds that the birds despise. These cannons are typically placed apart from each other in about five acre increments throughout the agricultural fields, and must be manually activated every morning. However, the downside of using such cannons is that local anti-noise laws generally prohibit them from remaining operational throughout the night. As such, each cannon must be individually activated in the morning which is a very times-taking process, not to mention the additional time that it takes for all the cannons to become fully operational. This poses a serious problem to crop protection as the birds are known to become very active before sunrise which gives them few hours lead to devastate the crops.

The most effective measure of deterring birds is to physically patrol the agricultural fields armed with shotguns. In order to properly carry out this measure, an agricultural worker has to cover about twenty acres of space throughout the entirety of a day using an off-road vehicle. Obviously, this is extremely labor intensive, not to mention being very costly due to the high price of shotgun shells.

Thus, there exists a need for a system which can deter birds away from agricultural fields on a long-time basis so as to be effective throughout the entire agricultural season. Further, there exists a need for a system which can achieve such objective without the burdens of labor and cost that are associated with the bird deterrents of the prior art.

### BRIEF SUMMARY OF THE INVENTION

In accordance with the present invention, there is provided a system for deterring small animals away from a selected area. The system comprises a central support member having an axis of rotation. Moreover, at least one elongated member is attached to the central support member and extends radially with respect to the axis of rotation. Further, a motor is in mechanical communication with the central support member. The motor is operative to rotate the central support member about the axis of rotation for moving the elongated member(s) about the axis of rotation. Lastly, a controller is in electrical communication with the motor. The controller is configured to activate the motor to rotate the central support member intermittently about the axis of rotation. This moves the elongated member(s) to deter the small animals away from the selected area.

The central support member may have at least one aperture for extending the elongated member(s) therethrough and maintaining the same thereat. The central support member may include a collar. Preferably, the elongated member(s) is a rod.

The system of the present invention further comprises at least one attachment which is attached to the elongated member(s) and freely dangles therefrom. This attachment(s) is preferably fabricated from a reflective and/or flexible material. In the preferred embodiment, the attachment(s) is a strip which is fabricated from a mylar material.

The motor may have a rotating motor shaft connected to the central support member for rotating the central support member. In addition, the system of the present invention may further comprise a shaft which is disposed in mechanical communication with the motor.

In the present invention, the controller is configured to activate the motor to rotate the central support member in a direction of rotation for a first defined interval of time. In the first preferred embodiment, the controller is further configured to activate the motor to substantially stop the central support member after the first defined interval of time and continue the rotation in the direction of rotation for a second defined interval of time. In the second preferred embodiment, the controller is further configured to activate the motor to rotate the central support member in an opposite direction of rotation for a second defined interval of time after the first defined interval of time.

In the third preferred embodiment, the controller is further configured to activate the motor to substantially stop the central support member after the first defined interval of time and rotate the central support member in an opposite direction of rotation for a second defined interval of time. The system of the present invention may further comprise a battery and/or solar panel in electrical communication with the motor.

### BRIEF DESCRIPTION OF THE DRAWINGS

These as well as other features of the present invention will become more apparent upon reference to the drawings wherein:

FIG. 1 is a perspective view of a bird deterrent system constructed in accordance with a preferred embodiment of the present invention and including a central support member which extends at least one elongated member radially with respect to its axis of rotation;

FIG. 2 is a partial perspective view of the bird deterrent system of FIG. 1 and illustrating the central support member which rotates about its axis of rotation to move the elongated member(s) in a direction of rotation;

FIG. 3 is a partial perspective view of the bird deterrent system of FIG. 1 and illustrating the central support member which rotates about its axis of rotation to move the elongated member(s) in an opposite direction of rotation; and

FIG. 4 is a partial perspective view of the central support member of FIG. 1 and illustrating the manner in which the elongated member(s) is engaged and maintained thereat.

### DETAILED DESCRIPTION OF THE INVENTION

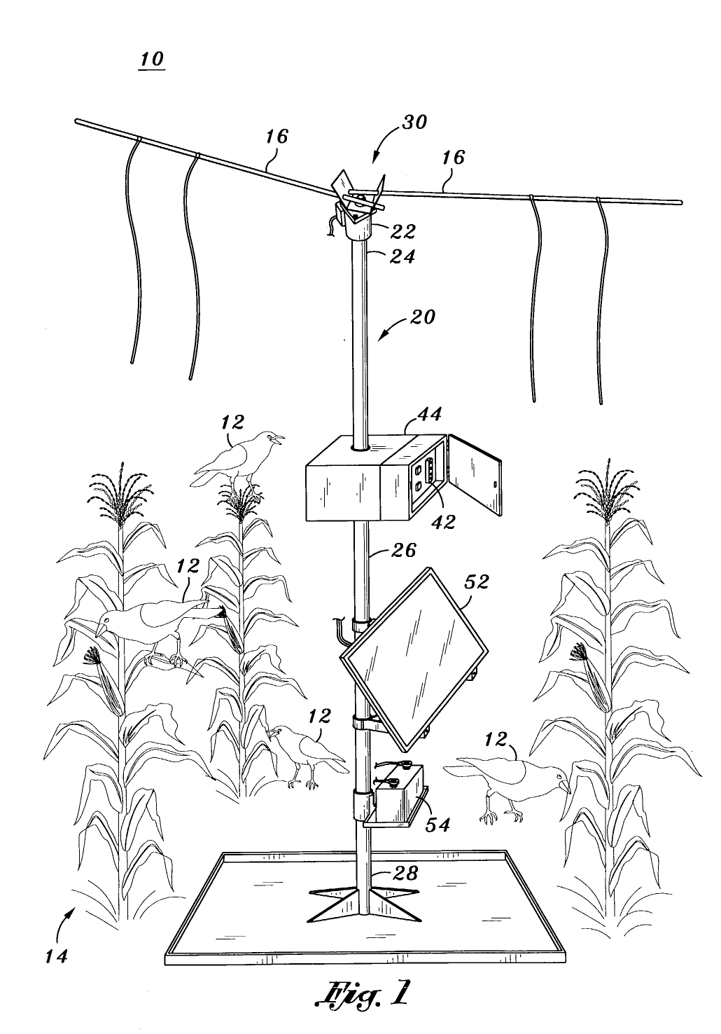

Referring now to the drawings wherein the showings are for purposes of illustrating preferred embodiments of the present invention only, and not for purposes of limiting the same, FIG. 1 perspectively illustrates a bird deterrent system 10 constructed in accordance with a preferred embodiment of the present invention. This system 10 is adapted to deter birds 12 away from agricultural fields 14 by moving at least one elongated member 16 intermittently about its axis of rotation 18. It should be expressly recognized herein that the present bird deterrent system 10 may be utilized in different settings and contexts such as to chase away other types of small animals (e.g., squirrels, field rats, moles, etc.), and/or placed on top or near residential and/or commercial structures to mitigate defacing of properties.

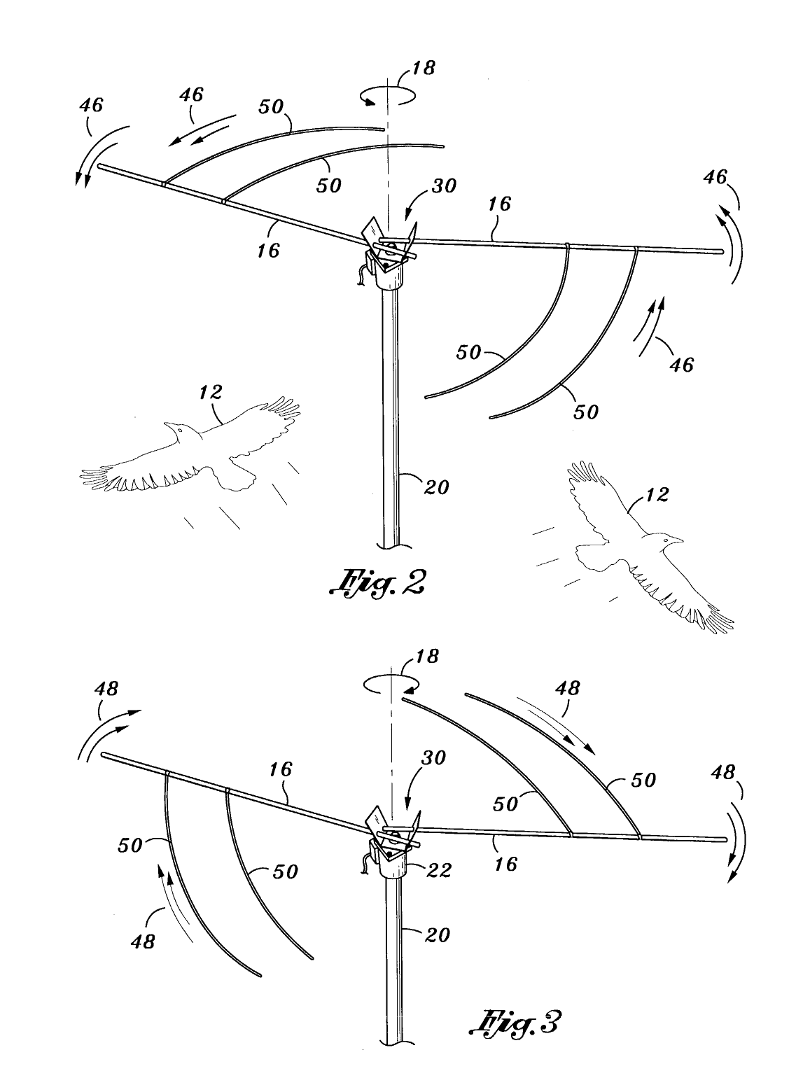

Referring more particularly to FIGS. 1 and 2, the bird deterrent system 10 of the present invention features a mounting member 20 which is deployable within the agricultural fields 14. Although this mounting member 20 may be variably sized, shaped and materialized, it is preferably a shaft that can be erected vertically upward within the agricultural field 14. The preferred shaft may be fabricated from any rigid material such as metal or plastic.

A motor 22 is mounted on top mounting portion 24 of the mounting member 20. However, as will be demonstrated below, such specific arrangement is not a requirement to fully perform the function of the motor 22. In this regard, it is foreseeable to mount the motor 22 along any of the locations of the mounting member 20 including its intermediate and bottom mounting portions 26, 28.

There is provided a central support member 30 which is placed in mechanical communication with the motor 22. In the preferred embodiment, the central support member 30 is located on top motor portion 32 of the motor 22 and is connected to its rotating motor shaft 34. Such mechanical connection may be achieved through fitting the rotating motor shaft 34 within a collar 36 of the central support member 30. By establishing such connection, the motor shaft 34 can be rotated by the motor 22 in two opposing directions which in turn causes the central support member 30 to rotate correspondingly along the same direction. Of course, the rotating speed of the motor shaft 34 may vary to effectuate the desired speed of the central support member 30 and the elongated member(s) 16 attached thereto. This variation of the rotating speed may be implemented in any manner or fashion such as through the use of a system's controller 42, the details of which will be better explained below. Moreover, it should be further noted herein that the rotating speed of the motor shaft 34 may be adjustable depending upon the type and length of the elongated member(s) 16 used.

Although not shown in any of the figures, various alternative designs of the present bird deterrent system 10 are contemplated herein which may accomplish the same function, that is, to rotate the central support member 30. For instance, the use of the mounting member 20 may be eliminated all together in which case a lengthened rotating motor shaft 34 is extended vertically upward from a ground-disposed motor 22 to rotate the central support member 30. Further exemplary to such depictions of alternative designs is to position the motor 22 relative to the intermediate or bottom mounting portion 26, 28 of the mounting member 20 wherein it is directly communicated to the upwardly disposed central support member 30 which is configured to rotate by itself without the use of a motor shaft 34. As such, various alternative designs of the present bird deterrent system 10 are foreseeable for rotating the central support member 30.

A multi-wound torsion spring (not shown) may be optionally used when the central support member 30 and its collar 36 are separately formed and interconnected to each other rather than simply being one integral component. In this respect, the multi-wound torsion spring may be provided between the central support member 30 and its collar 36 so as to tighten on the central support member 30 when the collar 36 is driven by the motor 22 in a particular direction. Such phenomenon causes the central support member 30 to achieve gradual acceleration as the torsion spring winds up, eventually matching the rotational speed of the collar 36. When the motor 22 becomes deactivated, the inertia of the central support member 30 causes the torsion spring to unwrap and release its tension on the central support member 30 which allows it to coast to a stop. This permits the motor 22 to start and stop without any shock being transmitted through the gear reduction.

One desired method of accomplishing such objective is to electronically control the motor 22 for soft start and stop. More particularly, the motor 22 may be “ramped up”, that is, an increasing amount of voltage may be supplied to the motor 22 in the start-up phase until it reaches maximum volts (e.g., 11.4 volts). Thereafter, the motor 22 may be “ramped down” in which the amount of voltage supplied thereto is gradually decreased until the motor 22 comes to a stop. This concept of “ramp up” and “ramp down” provides the motor 22 and gearhead adequate protection against sudden starts and stops, not to mention preventing excessive current surge in the start-up phase.

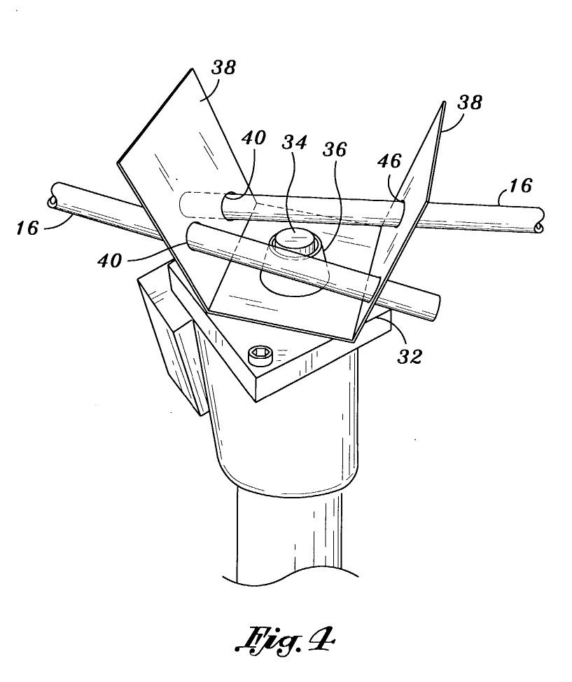

Referring now to FIGS. 1 and 4, there is provided at least one elongated member 16 which is attached to the central support member 30. The elongated member(s) 16 may be attached to the central support member 30 in any manner or fashion such as through fastening or adhering. However, in the preferred embodiment, the central support member 30 defines vertical peripheral flanges 38 with apertures 40 formed therethrough. By forming this configuration, the elongated member(s) 16 may extend through such apertures 40 and be maintained in place (best shown in FIG. 3).

The elongated member(s) 16 is preferably a rod which may be fabricated from any rigid material such as metal or hard plastic. Although any number of elongated member(s) 16 may be utilized with the present bird deterrent system 10, it is recognized herein that two elongated members 16 may be sufficient to optimally achieve the present invention's objective of deterring birds.

Upon being attached to the central support member 30, the elongated member(s) 16 extends radially with respect to the axis of rotation 18 of the central support member 30. Although only radial extension is shown and described, it is contemplated herein that the elongated member(s) 16 may extend outward in any manner or fashion including, but not limited to, angular or non-radial extension. It is the essence of being extended away from the central support member 30 that should be appreciated.

Because the elongated member(s) 16 is attached to the central support member 30, it is caused to move along with the central support member 30 about the axis of rotation 18. A controller 42 is provided with the present bird deterrent system 10 to control such movement of the central support member 30, and hence the movement of the elongated member(s) 16 as well. More specifically, the controller 42 is placed within a control box 44 and is placed in electrical communication with the motor 22. Although the control box 44 is depicted as being mounted to the mounting member 20, it should be recognized that such box 44 may be placed apart from the mounting member 20 as the electrical connection from the controller 42 to the motor 22 may also be achieved from this configuration.

Referring now to FIGS. 1-3, the controller 42 utilized with the present bird deterrent system 10 is essentially configured to activate the motor 22 for the purpose of rotating the central support member 30 intermittently about its axis of rotation 18. As amply stated above, this in turn causes the elongated member(s) 16 to move in two opposing directions, namely, in a direction of rotation 46 or in an opposite direction thereto 48. As will be explained below, these directions of rotations 46, 48 may even occur in combination to enhance the startling effect upon the birds 12.

In particular, the controller 42 operates to activate the motor 22 in order to cause the motor 22 to rotate the central support member 30 in the manner described above. The central support member 30 is rotated about its axis of rotation 18 which induces the elongated member(s) 16 to move either in the direction of rotation 46 or in the opposite direction of rotation 48 at various pre-selected or random speeds. This movement of the elongated member(s) 16 continues for a first defined interval of time which may be set at various durations. For example, the elongated member(s) 16 may move for about twenty-two seconds in one particular direction of rotation 46 or 48 and pause for a given amount of time (e.g., hundred and eight seconds) until the next rotational cycle. Ultimately, such continuous intermittent movement of the elongated member(s) 16 throughout the day would startle the birds 12, and hence deter them from settling on the agricultural fields 14.

Furthermore, the controller 42 may be adjusted or set differently to alter the rotation of the central support member 30, thus affecting the ultimate movement of the elongated member(s) 16. In one embodiment, the controller 42 controls the motor 22 to stop the central support member 30 for a short amount of time (e.g., five seconds or less) after being rotated in the direction of rotation 46 for the first defined interval of time. After this short pause, the central support member 30 would then be rotated again in the same direction 46 for a second defined interval of time. The second defined interval of time may be equivalent to the first interval of time, or substantially shorter or longer than thereto. Such adjusted intermittent movements of the elongated member(s) 16 increase the startling of the birds 12 which proportionally increase the deterring effect.

In a different embodiment, the controller 42 may be configured to subject the elongated member(s) 16 to a different type of movement. Specifically, the controller 42 may control the motor 22 to first rotate the central support member 30 in the direction of rotation 46 for the first defined interval of time. Immediately thereafter, the controller 42 would then switch the rotation of the central member 30 into the opposite direction of rotation 48 for the second defined interval of time. Such immediate switching of the directions of rotation 46, 48 obviously causes the elongated member(s) 16 to switch their movements in a corresponding manner which have a significant startling effect upon the birds 12.

In a further different embodiment, the controller 42 may be set to implement a slightly different type of movement than the ones just described. In this embodiment, the central support member 30 is stopped for a short amount of time (e.g., five second or less) before switching from the direction of rotation 46 to the opposite direction of rotation 48. This provides an alternative mode of movement for startling and deterring the birds 12.

It should be recognized that the controller 42 may employ the use of a timer (not shown) for regulating the first and/or second defined interval of time. The controller 42 may incorporate such timer therewithin, or alternatively be placed in electrical communication with an outside located one. Moreover, the controller 42 may additionally be configured to read the degree of light or brightness in the sky to activate the motor 22 prior to sunrise (e.g., approximately an half hour before sunrise). In the similar fashion, the controller 42 would operate to deactivate the motor 42 for the night as the light fades at sunset.

There may also be provided at least one attachment 50 for further increasing the startling effect upon the birds 12 which would proportionally deter them from settling on the agricultural fields 14. More specifically, one or more of the attachments 50 may be attached to each of the elongated members 16 provided. Preferably, they are tied to the elongated members 16 and freely dangle therefrom. The attachment(s) 50 is essentially provided to reflect sunlight and create flashes of light which the birds 12 despise, thus enhancing the deterrence effect. In this regard, such attachment(s) 50 is preferably fabricated from a reflective material that would meet this specified goal.

Further, the attachment(s) 50 is preferably fabricated from a flexible material. By being flexible, the attachment(s) 50 would generate sounds that irritate the birds 12 while being rotated against the wind. An exemplary attachment 50 which satisfies both the reflective and flexible preferences would be a strip that is fabricated from a mylar material.

The bird deterrent system 10 of the present invention may comprise a solar panel 52 which is placed in electrical communication with the motor 22. The solar panel 52 primarily serves to provide sufficient electrical power to drive the motor 22 during strong daylight hours. The solar panel 52 may further serve to charge the battery 54 with its excess generated power for conducting operation when the sunlight cannot be adequately provided. A typical solar panel 52 that may be used for these purposes is a photovoltaic solar panel.

Because the battery 54 is also electrically connected to the motor 22, it should be contemplated herein that the present bird deterrent system 10 may become operational through the sole use of the battery 54 alone. A typical battery 54 which may be used is a small lead-acid sealed 12 V, 7.5 Amp hour battery. Moreover, it should further be contemplated herein that the bird deterrent system 10 of the present invention may draw its required electrical power from a power source different than the ones indicated above. For example, the required electrical power may be delivered from a stand-alone power generator or an electrical outlet.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A system for deterring small animals away from a selected area, the system comprising:
a central support member having an axis of rotation;
at least one elongated member attached to the central support member and extending radially with respect to the axis of rotation;
a motor in mechanical communication with the central support member and being operative to rotate the central support member about the axis of rotation for moving the elongated member(s) about the axis of rotation; and
a controller in electrical communication with the motor, the controller being configured to activate the motor to rotate the central support member intermittently about the axis of rotation for moving the elongated member(s) to deter the small animals away from the selected area.

2. The system of claim 1 wherein the central support member has at least one aperture for extending the elongated member(s) therethrough and maintaining the same thereat.

3. The system of claim 1 wherein the central support member includes a collar.

4. The system of claim 1 wherein the elongated member(s) is a rod.

5. The system of claim 1 further comprising at least one attachment attached to the elongated member(s) and freely dangling therefrom.

6. The system of claim 5 wherein the attachment(s) is fabricated from a reflective material.

7. The system of claim 5 wherein the attachment(s) is fabricated from a flexible material.

8. The system of claim 5 wherein the attachment(s) is a strip.

9. The system of claim 5 wherein the strip is fabricated from a mylar material.

10. The system of claim 1 wherein the motor has a rotating motor shaft connected to the central support member for rotating the central support member.

11. The system of claim 1 further comprising a shaft, the shaft being disposed in mechanical communication with the motor.

12. The system of claim 1 wherein the controller is configured to activate the motor to rotate the central support member in a direction of rotation for a first defined interval of time.

13. The system of claim 12 wherein the controller is further configured to activate the motor to substantially stop the central support member after the first defined interval of time and continue the rotation in the direction of rotation for a second defined interval of time.

14. The system of claim 12 wherein the controller is further configured to activate the motor to rotate the central support member in an opposite direction of rotation for a second defined interval of time after the first defined interval of time.

15. The system of claim 12 wherein the controller is further configured to activate the motor to substantially stop the central support member after the first defined interval of time and rotate the central support member in an opposite direction of rotation for a second defined interval of time.

16. The system of claim 1 further comprising a battery in electrical communication with the motor.

17. The system of claim 1 further comprising a solar panel in electrical communication with the motor.
